(19) United States
(12) Patent Application Publication
(10) Pub. No.: US 2021/0049953 A1
(43) Pub. Date: Feb. 18, 2021

(54) LED DISPLAY DEVICE HAVING MINIMIZED NUMBER OF INTERFACING LINES

(71) Applicant: RECOS Inc., Seoul (KR)

(72) Inventor: Soonwon HONG, Seoul (KR)

(73) Assignee: RECOS Inc., Seoul (KR)

(21) Appl. No.: 16/906,500

(22) Filed: Jun. 19, 2020

(30) Foreign Application Priority Data
Aug. 13, 2019 (KR) 10-2019-0098543

(51) Int. Cl. G09G 3/32

(52) U.S. Cl. CPC G09G 3/32; G09G 2330/028; G09G 2310/0243

(57) ABSTRACT

A light-emitting diode display device includes a first power supply line transmitting a first supply voltage, a second power supply line transmitting a second supply voltage, a power switching part selectively connecting internal power lines of the display panel to the first power supply line; light emission sets each including light emission units emitting light having a quantity according to an amount of charges flowing between first and second unit terminals, driving sets each disposed between the interfacing line of a corresponding one of the light emission sets and the second power supply line and driven using a data set, wherein each of the driving sets is driven to allow charges having an amount corresponding to a drive data to flow to the interfacing line during each of the light emission periods, and a drive data supplier that provides the drive data to the driving sets.

### CROSS-REFERENCE TO RELATED APPLICATION

This application claims priority to and the benefit of Korean Patent Application No. 2019-0098543, filed on Aug. 13, 2019, the disclosure of which is incorporated herein by reference in its entirety.

### BACKGROUND

### 1. Field of the Invention

The invention relates to a light-emitting diode (LED) display device, and more particularly, to LED display modules which are disposed in a display device and individually driven by respective driver integrated circuit (IC) chips.

### 2. Discussion of Related Art

Recently, light-emitting diode (LED) billboards or LED advertising boards employing LEDs are being widely used as billboards or advertising boards on exteriors of buildings. For convenience in production and maintenance, these LED billboards or LED advertising boards are generally formed of a plurality of LED display modules.

In this case, each of the LED display modules includes a display panel and a driver integrated circuit (IC) chip which is driven so that the display panel displays an image. A plurality of light emission sets, each including red (R), green (G), and blue (B) LEDs emitting light, are arranged in the display panel at regular intervals. Further, a plurality of driving sets which are driven so that the R, G, and B LEDs of the light emission sets emit light are disposed in the driver IC chip.

Recently, in order to improve quality of an image, LED display devices are implemented with an increased resolution of 2K, 4K, or 8K. In order to manufacture such a high-definition display, it is desired to maximize the number of light emission sets disposed in a predetermined area. In this case, one factor to be considered is minimizing the number of interfacing lines between the display module and the driver IC chip.

Meanwhile, one method of implementing an LED display device is manufacturing and implementing a driver IC chip which includes driving sets capable of simultaneously driving three light emission units, such as R, G, and B LEDs, which constitute a single light emission set. It is possible to implement such LED display device by connecting each of the LED light emission units of the LED display panel to a corresponding one of the driving sets of the driver IC chip.

However, in the above method of implementing an LED display device, since the number of interfacing lines between the display panel and the driver IC chip and the number of pads of the driver IC chip increase in proportion to the square of resolution per unit area, there have been hurdles such that difficulty in wiring of the display panel and an area of the driver IC chip sharply increase.

For example, when a display panel is manufactured with a pixel pitch of 1 mm, the number of light emission sets included in a display module having a width of 10 cm and a height of 10 cm becomes 10,000. In this case, in consideration that three R, G, and B LED light emission units are included in each light emission set, about 30,000 interfacing lines are needed between the display module and the driver IC chip.

Therefore, in order to implement a high resolution LED display device, it is especially important to reduce the number of interfacing lines to decrease the number of pads in the driver IC chip.

### SUMMARY OF THE INVENTION

The disclosure is directed to a light-emitting diode (LED) display device in which the number of interfacing lines between a display panel and a driver integrated circuit (IC) chip is reduced and thus the number of pads of the driver IC chip is reduced.

According to an embodiment, an LED display device having a display panel and a driver IC chip driven to display an image on the display panel may include a first power supply line that transmits a first supply voltage; a second power supply line that transmits a second supply voltage; internal power lines disposed in the display panel; a power switching part that selectively connects the internal power lines to the first power supply line according to light emission periods; light emission sets each including light emission units each of which emits light having a quantity according to an amount of charges flowing between a first unit terminal and a second unit terminal, wherein at least two light emission units may emit light having different wavelengths, the first unit terminal of each of the light emission units is electrically connected to a corresponding one of the internal power lines, and the second unit terminal of each of the light emission units is commonly connected to an interfacing line of a corresponding one of the light emission sets; driving sets each of which is disposed between the interfacing line of a corresponding one of the light emission sets and the second power supply line and driven using a data set, wherein each of the driving sets is driven to allow charges having an amount corresponding to a drive data to flow to the interfacing line during each of the light emission periods; and a drive data supplier that provides the drive data to the driving sets. The light emission sets may be disposed in the display panel, and the driving sets may be disposed in the driver IC chip.

The driving sets may include first to n^{th} driving sets, the drive data supplier may provide first to m^{th} drive data to each of the first to n^{th} driving sets, and the amount of the charges flowing the interface line during i^{th} light emission period may correspond to a data value of i^{th} drive data.

Each of the light emission units may include an LED disposed between the first unit terminal and the second unit terminal, the LED emitting light according to a current flowing the LED; and a reset part disposed between the first unit terminal and the second unit terminal and in parallel with the LED, wherein the reset part resets the current of the LED.

The resent part may include a reset switch disposed between the first unit terminal and the second unit terminal and turned on at a reset timing; and a reverse current prevention element disposed between the first unit terminal and the second unit terminal and in series with the reset switch, the reverse current prevention element preventing generation of a reverse current. The reverse current prevention element may have a current path of which a direction is same as a direction of a current path of the LED.

Each of the driving sets may include current sourcing parts corresponding to the light emission units and disposed in parallel between the interfacing line and the second power supply line, wherein each of the current sourcing parts may include a current source and a driving switch which are connected in series, the current source may provide a predetermined current amount, and the driving switch may be turned on during activation of an driving timing signal; and a driving timing generator that provides driving timing signals to the current sourcing parts, wherein a driving timing signal may be activated for a time period corresponding to a drive data during a corresponding light emission period. When the driving switch of each of the current sourcing parts is turned-on for a maximum period, an amount of current of the current source of each of the current sourcing parts may correspond to an amount of current which causes an image of the display panel to have white light having maximum brightness due to mixture of light emitted from the corresponding light emission units.

Each of the driving sets may include a variable current source disposed between the interfacing line and the second power supply line, an amount of current flowing the variable current source varying based on a driving level signal; and a driving level generator that provides the driving level signal to the variable current source, wherein the driving level signal may have a driving level corresponding to the drive data during a corresponding light emission period.

Each of the driving sets may include a variable current source disposed between the interfacing line and the second power supply line, an amount of current flowing the variable current source varying based on a driving level signal; a driving switch disposed between the interfacing line and the second power supply line and in series with the variable current source, the driving switch being turned on based on activation of a driving timing signal; and a driving signal generator that generates the driving level signal and the driving timing signal. The driving level signal may have a driving level corresponding to the drive data during a corresponding light emission period, and the driving timing signal may be activated a time period corresponding to the drive data during a corresponding light emission period.

### BRIEF DESCRIPTION OF THE DRAWINGS

The above and other objects, features and advantages of the invention will become more apparent to those skilled in the art by describing in detail exemplary embodiments thereof with reference to the accompanying drawings, in which:

FIG. 1 is a schematic diagram illustrating a light-emitting diode (LED) display device according to one embodiment of the invention;

FIG. 2 is a schematic diagram illustrating a power switching part of FIG. 1;

FIG. 3 is a graphical view of signal waveforms for describing driving of the power switching part of FIG. 2;

FIG. 4 is a schematic diagram illustrating a light emission set of FIG. 1;

FIG. 5 is a schematic diagram for describing a leakage current which may occur when a reverse current prevention element of FIG. 4 is not provided;

FIG. 6 is a schematic diagram illustrating an embodiment of a driving set of FIG. 2;

FIG. 7 is a schematic diagram illustrating another embodiment of the driving set of FIG. 2; and

FIG. 8 is a schematic diagram illustrating another embodiment of the driving set of FIG. 2.

### DETAILED DESCRIPTION OF EXEMPLARY EMBODIMENTS

Hereinafter, embodiments of the invention will be described in detail with reference to the accompanying drawings.

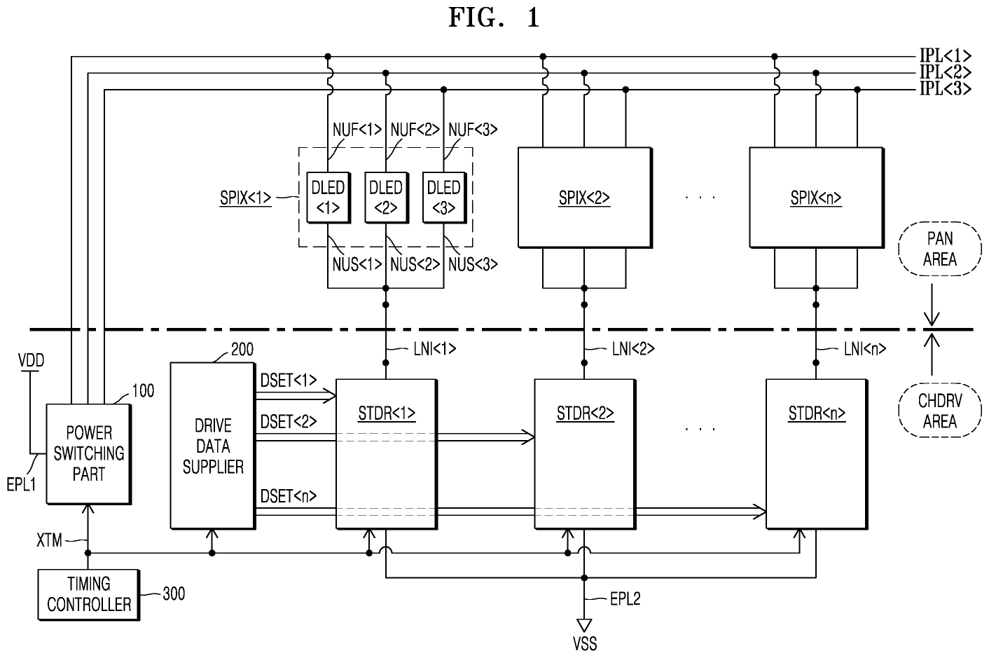

FIG. 1 is a schematic diagram illustrating a light-emitting diode (LED) display device according to an embodiment. Referring to FIG. 1, the LED display device including an LED display module which includes a first power supply line EPL1, a second power supply line EPL2, first to m^{th} internal power lines IPL<1> to IPL<m>, a power switching part 100, first to n^{th} light emission sets SPIX<1> to SPIX<n>, first to n^{th} driving sets STDR<1> to STDR<n>, and a drive data supplier 200.

For example, ‘m’ may be a natural number of three or more, and in the embodiment of FIG. 1, m is three. Also, ‘n’ may be a natural number of two or more.

The first power supply line EPL1 transmits a first supply voltage, and the second power supply line EPL2 transmits a second supply voltage. In the embodiment of FIG. 1, the first supply voltage is a power supply voltage VDD, and the second supply voltage is a ground voltage VSS.

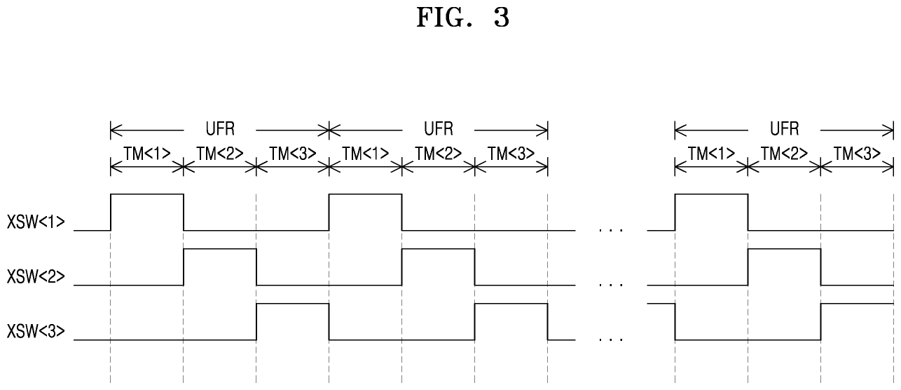

The power switching part 100 is driven to selectively connect the first to third internal power lines IPL<1> to IPL<3> to the first power supply line EPL1 corresponding to first to third light emission periods TM<1> to TM<3> (see FIG. 3) in one unit frame UFR (see FIG. 3).

Each of the first to n^{th} light emission sets SPIX<1> to SPIX<n> includes first to third light emission units DLED<1> to DLED<3>. Each of the first to third light emission units DLED<1> to DLED<3> emits light having a quantity according to an amount of charges flowing between a first unit terminal NUF and a second unit terminal NUS. For example, at least two light emission units DLED among the first to third light emission units DLED<1> to DLED<3> respectively emit light having a different intrinsic wavelength. In other words, a wavelength of light emitted from a light emission unit is different from a wavelength of light emitted from another light emission unit.

For example, the first, second, and third light emission units DLED<1>, DLED<2>, and DLED<3> may emit red (R) light, green (G) light, and blue (B) light, respectively.

In the embodiment, the first unit terminal NUF of each of the first to third light emission units DLED<1> to DLED<3> is electrically connected to a corresponding one of the first to third internal power lines IPL<1> to IPL<3>. The second unit terminals NUS of the first to third light emission units DLED<1> to DLED<3> may be commonly connected to an interfacing line LNI which is disposed corresponding to the light emission set SPIX of the first to third light emission units DLED<1> to DLED<3>.

In the embodiment, the first to n^{th} driving sets STDR<1> to STDR<n> are disposed between the interfacing line LNI of the first to n^{th} light emission sets SPIX<1> to SPIX<n> and the second power supply line EPL2.

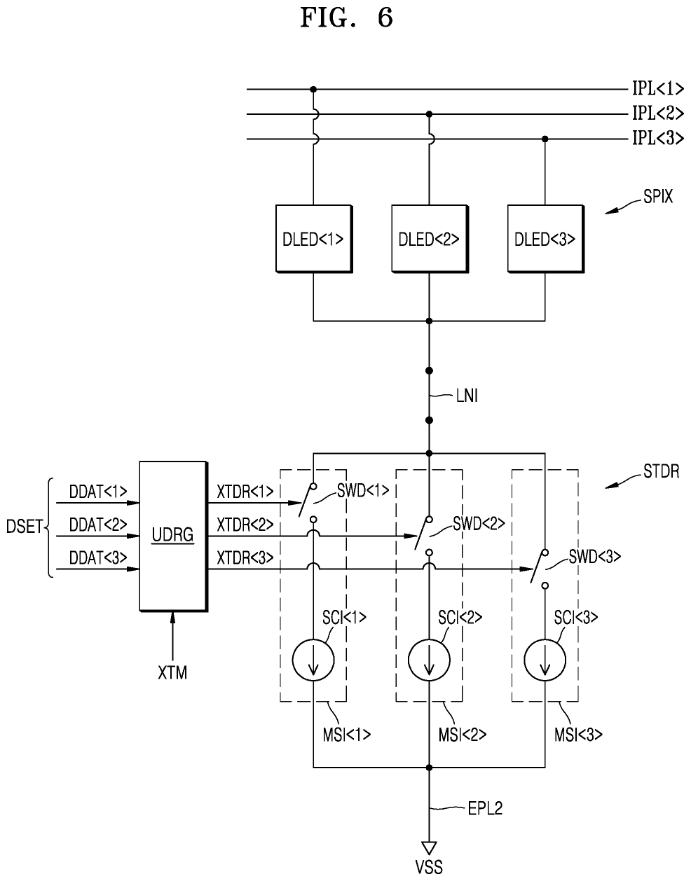

The first to n^{th} driving sets STDR<1> to STDR<n> are driven in response to first to third drive data DDAT<1>, DDAT<2>, and DDAT<3> (see FIGS. 6 to 8).

In the embodiment of FIG. 1, first to n^{th} data sets DSET<1> to DSET<n> are provided to the first to n^{th} driving sets STDR<1> to STDR<n>, respectively, each data set may include the first to n^{th} drive data DDAT<1> to DDAT<n>.

In order to allow the first to third light emission units DLED<1> to DLED<3> of each emission set to emit light having brightness corresponding to the first to third drive data DDAT<1> to DDAT<3>, respectively, during the first to third light emission periods TM<1> to TM<3>, respectively, each of the first to third driving sets STDR<1> to STDR<3> is driven to allow a corresponding amount of charges to flow to the interfacing line LNI.

The drive data supplier 200 is driven to provide the first to third drive data DDAT<1> to DDAT<3> to the first to third driving sets STDR<1> to STDR<3>.

In the embodiment of FIG. 1, a timing controller 300 controls an operation timing of a display panel PAN by providing a timing control signal XTM to the power switching part 100, the light emission sets SPIX, the driving sets STDR, and the drive data supplier 200 to display images on the display panel PAN.

The LED display module according to an embodiment may include a driver IC chip CHDRV which is driven to display images on the display panel PAN.

In this embodiment, the internal power lines IPL and the light emission sets SPIX may be disposed in the display panel PAN. The first power supply line EPL1, the second power supply line EPL2, the power switching part 100, the driving sets STDR, and the drive data supplier 200 may be disposed in the driver IC chip CHDRV. The timing controller 300 may also be disposed in the driver IC chip CHDRV. However, the disposition and configuration of those elements of the invention are not limited thereto.

In the LED display module according to this embodiment, a single interfacing line LNI may be provided for each light emission set SPIX including the first to third light emission units DLED<1> to DLED<3>. Thus, the LED display module of this embodiment may make it possible to minimize the number of interfacing lines LNI between the display panel PAN and the driver IC chip CHDRV and, thus, minimizing the number of pads of the driver IC chip CHDRV.

The components of the LED display module according to the invention will be described in detail.

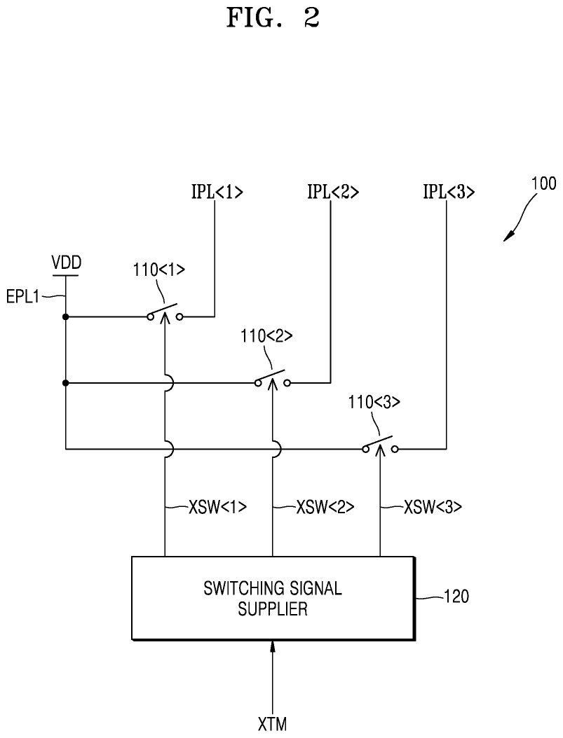

FIG. 2 is a schematic diagram illustrating the power switching part 100 of FIG. 1. In this embodiment, the power switching part 100 includes first to third power switches 110<1> to 110<3> and a switching signal supplier 120.

The first power switch 110<1> connects the first internal power line IPL<1> to the first power supply line EPL1 during activation of a first switching signal XSW<1>, and the second power switch 110<2> connects the second internal power line IPL<2> to the first power supply line EPL1 during activation of a second switching signal XSW<2>. The third power switch 110<3> connects the third internal power line IPL<3> to the first power supply line EPL1 during activation of a third switching signal XSW<3>.

For example, each of the first to third power switches 110<1> to 110<3> is implemented as a p-type metal oxide semiconductor (PMOS) transistor, and activation states of the first to third switching signals XSW<1> to XSW<3> are “L” states.

The switching signal supplier 120 provides the first to third switching signals XSW<1> to XSW<3>. As shown in FIG. 3, the first to third switching signals XSW<1> to XSW<3> are sequentially activated during the first to third light emission periods TM<1> to TM<3> which are sequential in one unit frame and for which one image is displayed.

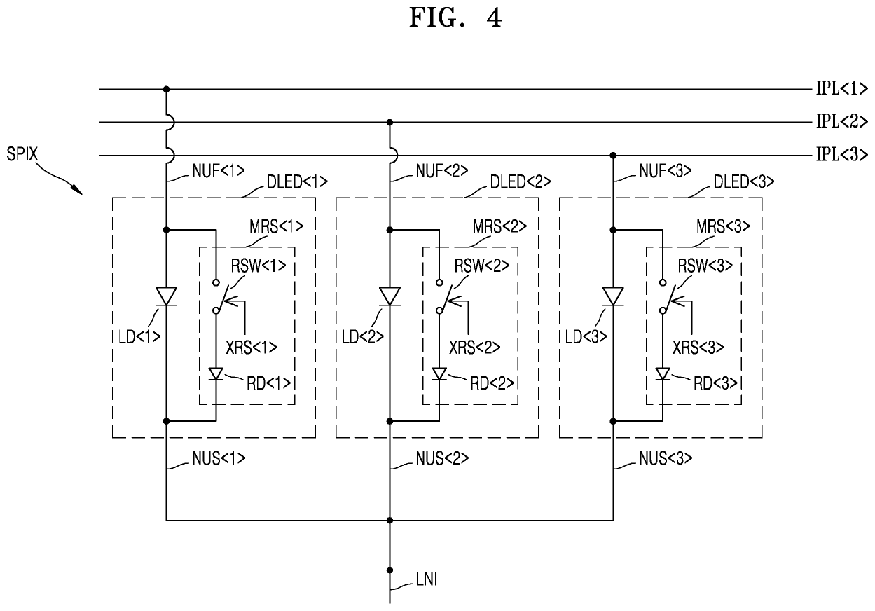

FIG. 4 is a schematic diagram illustrating the light emission set SPIX of FIG. 1. In the embodiment of FIG. 4, each of the first to third light emission units DLED<1> to DLED<3> of the light emission set SPIX includes an LED LD and a reset part MRS.

The LED LD is disposed between a first unit terminal NUF and a second unit terminal NUS of a corresponding light emission unit DLED and emits light according to a current flowing between the first unit terminal NUF and the second unit terminal NUS.

In the embodiment of FIG. 4, an anode terminal of the LED LD of each of the first to third light emission units DLED<1> to DLED<3> is connected to the first unit terminal NUF of the corresponding light emission unit DLED. A cathode terminal of the LED LD of each of the first to third light emission units DLED<1> to DLED<3> is connected to the second unit terminal NUS of the corresponding light emission unit DLED.

For example, an LED LD<1> of the first light emission unit DLED<1> emits R light (610<λ<760), and an LED LD<2> of the second light emission unit DLED<2> emits G light (500<λ<570). An LED LD<3> of the third light emission unit DLED<3> emits B light (450<λ<500).

The reset part MRS is disposed between the first unit terminal NUF and the second unit terminal NUS of the corresponding light emission unit DLED and connected to the LED LD in parallel.

The reset part MRS may reset the LED LD. The reset of the LED LD is performed by minimizing a voltage difference between the first unit terminal NUF and the second unit terminal NUS.

In the embodiment, the reset part MRS includes a reverse current prevention element RD and a reset switch RSW which are electrically connected in series between the first unit terminal NUF and the second unit terminal NUS of the corresponding light emission unit DLED.

The reset switch RSW is turned on in response to a diode reset signal XRS activated at a reset timing. For example, a reset switch RSW<1> of the first light emission unit DLED<1> may be turned on while an LED LD<2> of the second light emission unit DLED<2> or an LED LD<3> of the third light emission unit DLED<3> emits light.

The reverse current prevention element RD prevents occurrence of a reverse current. The reverse current prevention element RD may be an element having a current path of which a direction is the same as a direction of a current path of the LED LD and capable of performing a diode function. For example, a threshold voltage of the reverse current prevention element RD be smaller than a threshold voltage of the LED LD.

In the embodiment of FIG. 4, the interfacing lines LNI of the light emission sets SPIX are controlled by different voltage levels or different amounts of currents.

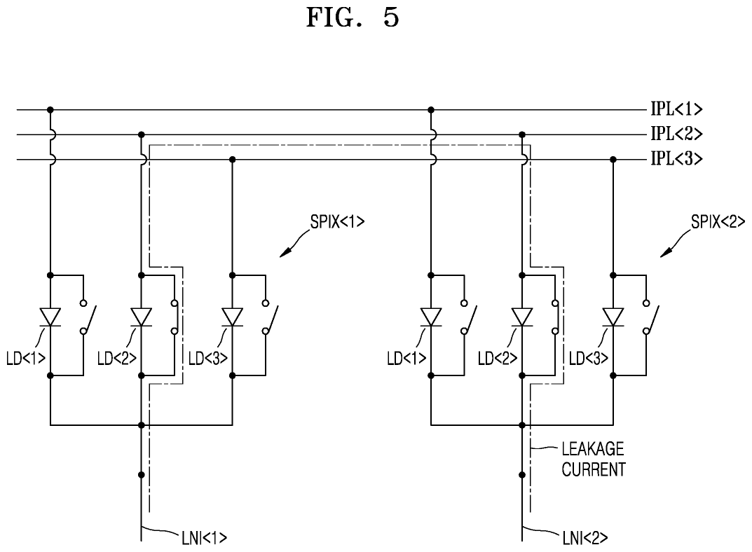

In an example shown in FIG. 5, no reverse current prevention element is provided in the light emission unit DLED of the light emission set SPIX. In this case, a leakage current may be generated during a reset operation of the light-emitting diode LD.

In contrast, in the embodiment of FIG. 4, generation of a leakage current during a reset operation may be blocked due to the reverse current prevention element RD.

Embodiments of the driving set STDR will be described in detail.

FIG. 6 is a schematic diagram illustrating an embodiment of the driving set according to an embodiment. Referring to FIG. 6, the driving set STDR includes first to third current sourcing parts MSI<1> to MSI<3> and a driving timing generator UDRG.

The first to third current sourcing parts MSI<1> to MSI<3> respectively correspond to first to third light emission units DLED<1> to DLED<3> of a corresponding one of the first to third light emission sets SPIX<1> to SPIX<3> and are disposed in parallel between a corresponding interfacing line LNI and the second power supply line EPL2.

In the embodiment, each of the first to third current sourcing parts MSI<1> to MSI<3> includes a current source SCI and a driving switch SWD which are electrically connected in series.

For example, a driving switch SWD<i> of an i^{th} current sourcing part MSI<i> (here, i is a natural number ranging from one to m) is controlled to become a turned-on state during activation of an i^{th} driving timing signal XTDR<i>. Here, the i^{th} driving timing signal XTDR<i> remains in an activated state for a time period corresponding to a data value of i^{t}h drive data DDAT<i> during an i^{th} light emission period TM<i>.

In this case, the current source SCI of each of the first to third current sourcing parts MSI<1> to MSI<3> may be set to provide a target amount of current.

When driving switches SWD<1> to SWD<3> are controlled to be a turned-on state with a maximum period, the target amount of current of the current source SCI of each of the first to third current sourcing parts MSI<1> to MSI<3> is an amount of current which causes an image being displayed on the display panel PAN to have white light having a target maximum brightness due to an additive color mixture of quantities of light emitted from the first to third light emission units DLED<1> to DLED<3> of the light emission set SPIX<1> during the first to third light emission periods TM<1> to TM<3> (see FIG. 3).

The three light emission units DLED<1> to DLED<3> included in the light emission set SPIX generally may have different electrical characteristics and unique wavelengths.

Therefore, the target amount of current of the current source SCI of each of the first to third current sourcing parts MSI<1> to MSI<3> may be different according to a type of the light emission unit DLED.

For example, the first to third light emission units DLED<1> to DLED<3> may employ R, G, and B LED elements, and the R, G, and B LED elements may constitute a single light emission set SPIX. In this case, the R, G, and B LED elements may have different electrical characteristics. For example, the first to third light emission units DLED<1> to DLED<3> constituting one light emission set SPIX may have different amounts of currents which are required to emit white light due to an additive color mixture of quantities of light.

Light emission units emitting light having the same unique wavelength may have different electrical characteristics according to manufacturing process dispersion. Thus, in the embodiment of FIG. 6, the number of current sources SCI of each driving set STDR is configured to be equal to the number of the light emission units DLED included in one light emission set SPIX.

In the embodiment of FIG. 6, the driving timing generator UDRG generates first to third driving timing signals XTDR<1> to XTDR<3> having activation periods corresponding to the first to third drive data DDAT<1> to DDAT<3>.

In summary, in the LED display device including the driving set STDR of FIG. 6 according to the invention, the driving timing signal XTDR is activated for a time period corresponding to the drive data DDAT of each of the light emission units DLED of the light emission sets SPIX. Accordingly, the light-emitting diode LD of each of the light emitting units DLED emits light with brightness corresponding to each drive data DDAT.

In the LED display device including the driving set STDR of the embodiment of FIG. 6, a method of displaying an image in the LED display device may be easily understood by those skilled in the art, and thus a detailed description thereof will be omitted herein.

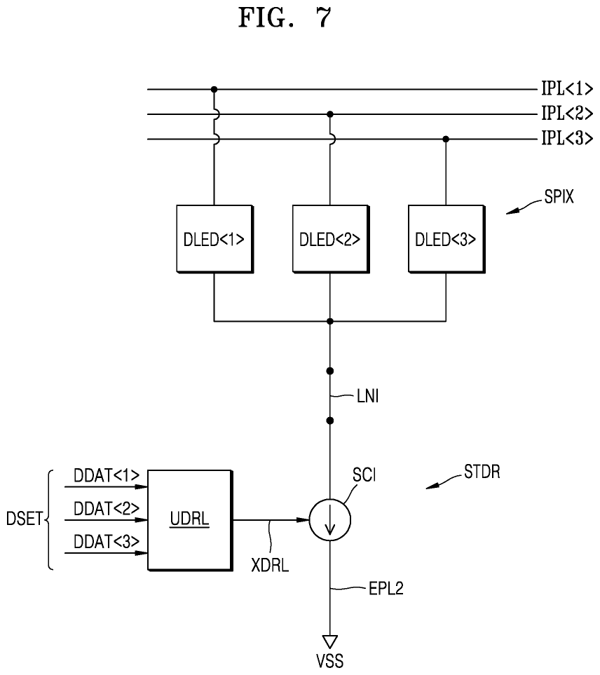

FIG. 7 is a schematic diagram illustrating another embodiment of the driving set of STDR of FIG. 1.

Referring to FIG. 7, a driving set STDR according to another example includes a variable current source SCI and a driving level unit UDRL.

The variable current source SCI is disposed between an interfacing line LNI and a second power supply line EPL2. In the embodiment, an amount of current flowing in the variable current source SCI is controlled according to a level of a driving level signal XDRL.

The driving level unit UDRL may generate driving level signals XDRL having driving levels corresponding to the first to third drive data DDAT<1> to DDAT<3> during the first to third light emission periods TM<1> to TM<3>.

The voltage level of the driving level signal XDRL corresponds to a data value of first drive data DDAT<1> during the first light emission period TM<1>, corresponds to a data value of second drive data DDAT<2> during the second light emission period TM<2>, and corresponds to a data value of third drive data DDAT<3> during the third light emission period TM<3>.

In the embodiment of FIG. 7, the driving level signal XDRL is a signal having a level corresponding to each drive data DDAT of each of the light emission units DLED of the light emission sets SPIX. Accordingly, a light-emitting diode LD of each of the light emitting units DLED of the light emission sets SPIX emits light with a brightness corresponding to each drive data DDAT.

In the LED display device including the driving set STDR of the embodiment of FIG. 7, a method of displaying an image may be easily understood by those skilled in the art, and thus a detailed description thereof will be omitted herein.

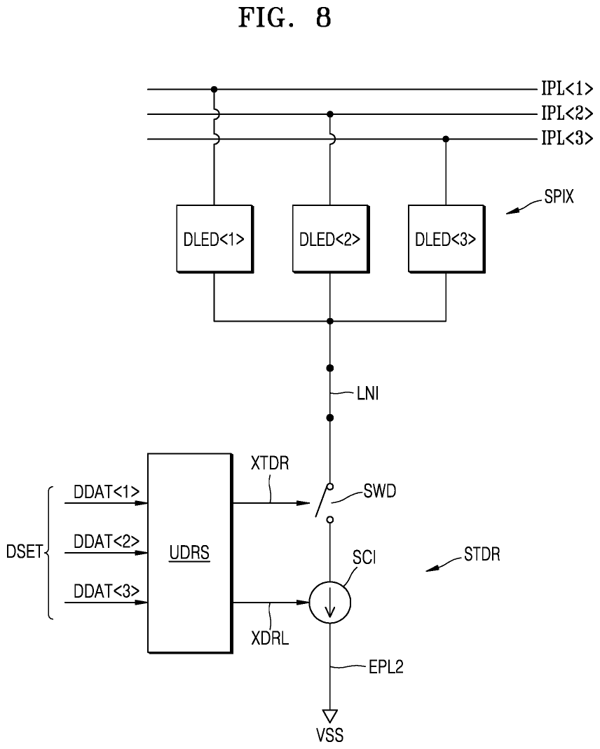

FIG. 8 is a schematic diagram illustrating another embodiment of the driving set of STDR of FIG. 1.

In the embodiment of FIG. 8, a driving set STDR includes a variable current source SCI, a driving switch SWD, and a driving signal generator UDRS.

The variable current source SCI is disposed between an interfacing line LNI and a second power supply line EPL2. In the embodiment, an amount of current flowing the variable current source SCI is controlled according to a level of a driving level signal XDRL.

The driving switch SWD is disposed between the interfacing line LNI and the second power supply line EPL2 in series with the variable current source SCI.

In addition, the driving switch SWD is turned on during a time period corresponding to activation of a driving timing signal XTDR.

A level of the driving level signal XDRL and an activation period of the driving timing signal XTDR correspond to a data value of an i^{th} drive data DDAT<i> during an i^{th} light emission period.

For example, the level of the driving level signal XDRL and the activation period of the driving timing signal XTDR correspond to a data value of first drive data DDAT<1> during a first light emission period TM<1>, correspond to a data value of a second drive data DDAT<2> during a second light emission period TM<2>, and correspond to a data value of a third drive data DDAT<3> during a third light emission period TM<3>.

The level of the driving level signal XDRL and the activation period of the driving timing signal XTDR may be controlled by various methods according to the drive data DDAT.

For example, the activation period of the driving timing signal XTDR may depend on an upper level bit data of the drive data DDAT, and the level of the driving level signal XDRL may depend on a lower level bit data of the drive data DDAT.

In the LED display device including the driving set STDR of the embodiment of FIG. 8, the level of the driving level signal XDRL and the activation period of the driving timing signal XTDR correspond to the drive data DDAT of each of the light emission units DLED of the light emission sets SPIX. Accordingly, a light-emitting diode LD of each of the light emitting units DLED of the light emission sets SPIX emits light with brightness corresponding to each drive data DDAT.

In the LED display device including the driving set STDR of the embodiment of FIG. 8, a method of displaying an image may be easily understood by those skilled in the art, and thus a detailed description thereof will be omitted herein.

While the invention has been described with reference to the embodiments shown in the drawings, these embodiments are merely illustrative and it should be understood that various modifications and other equivalent embodiments can be derived by those skilled in the art on the basis of the embodiments.

For example, in this disclosure, the embodiments in which the first supply voltage is the power supply voltage VDD and the second supply voltage is the ground voltage VSS have been illustrated and described. However, modifications apparent to those skilled in the art may be made within the concept of the invention. For example, the first supply voltage may be the ground voltage VSS and the second supply voltage may be the power supply voltage VDD. In this case, a connection relationship between the anode terminal and the cathode terminal of each of the light emission units DLED of the light emission set SPIX may be changed.

For example, the anode terminal of each of the light-emitting diodes LD of the light emission units DLED is connected to a second unit terminal NUS of a corresponding light emission unit DLED. The cathode terminal of each of the light-emitting diodes LD of the light emission units DLED is connected to a first unit terminal NUF of the corresponding light emission unit DLED.

Further, in this disclosure, the embodiments in which three light emission units are disposed in each of the light emission sets SPIX<1> to SPIX<n> have been illustrated and described. However, modifications apparent to those skilled in the art may be made within the concept of the invention. For example, the number of light emission units disposed in each of the light emission sets SPIX<1> to SPIX<n> may be extended to four or more. That is, in addition to the light emission units emitting R light, G light, and B light, a light emission unit emitting white light may be included in each of the light emission sets SPIX<1> to SPIX<n>. In this case, the number of internal power lines, the number of power switches included in the power switching part 100, the number of switching signals, and the number of light emission periods included in one unit frame are also extended to correspond to the number of light emitting units disposed in each of the light emission sets SPIX<1> to SPIX<n>.

In the embodiments of a light-emitting diode (LED) display module, a single interfacing line may be provided regardless of types or characteristics of first to m^{th} light emission units with respect to a light emission set including the first to m^{th} light emission units. Therefore, the number of interfacing lines between a display panel and a driver integrated circuit (IC) chip can be minimized so that the number of pads of the driver IC chip can be minimized.

It will be apparent to those skilled in the art that various modifications can be made to the above-described exemplary embodiments of the invention without departing from the spirit or scope of the invention. Thus, it is intended that the invention covers all such modifications provided they come within the scope of the appended claims and their equivalents.

What is claimed is:

1. A light-emitting diode (LED) display device having a display panel and a driver integrated circuit (IC) chip driven to display an image on the display panel, the LED display device comprising:
a first power supply line that transmits a first supply voltage;
a second power supply line that transmits a second supply voltage;
internal power lines disposed in the display panel;
a power switching part that selectively connects the internal power lines to the first power supply line according to light emission periods;
light emission sets each including:
light emission units each of which emits light having a quantity according to an amount of charges flowing between a first unit terminal and a second unit terminal, wherein
at least two light emission units emit light having different wavelengths,
the first unit terminal of each of the light emission units is electrically connected to a corresponding one of the internal power lines, and
the second unit terminal of each of the light emission units is commonly connected to an interfacing line of a corresponding one of the light emission sets;
driving sets each of which is disposed between the interfacing line of a corresponding one of the light emission sets and the second power supply line and driven using a data set, wherein each of the driving sets is driven to allow charges having an amount corresponding to a drive data to flow to the interfacing line during each of the light emission periods; and
a drive data supplier that provides the drive data to the driving sets, wherein
the light emission sets are disposed in the display panel, and
the driving sets are disposed in the driver IC chip.

2. The LED display device of claim 1, wherein
the driving sets include first to n^{th} driving sets,
the drive data supplier provides first to m^{th} drive data to each of the first to n^{th} driving sets, and
the amount of the charges flowing the interface line during i^{th} light emission period corresponds to a data value of i^{th} drive data.

3. The LED display device of claim 1, wherein each of the light emission units includes:
an LED disposed between the first unit terminal and the second unit terminal, the LED emitting light according to a current flowing the LED; and
a reset part disposed between the first unit terminal and the second unit terminal and in parallel with the LED, wherein the reset part resets the current of the LED.

4. The LED display device of claim 3, wherein the resent part includes:
a reset switch disposed between the first unit terminal and the second unit terminal and turned on at a reset timing; and
a reverse current prevention element disposed between the first unit terminal and the second unit terminal and in series with the reset switch, the reverse current prevention element preventing generation of a reverse current.

5. The LED display device of claim 4, wherein the reverse current prevention element has a current path of which a direction is same as a direction of a current path of the LED.

6. The LED display device of claim 1, wherein each of the driving sets includes:
current sourcing parts corresponding to the light emission units and disposed in parallel between the interfacing line and the second power supply line, wherein
each of the current sourcing parts includes a current source and a driving switch which are connected in series,
the current source provides a predetermined current amount, and
the driving switch is turned on during activation of a driving timing signal; and
a driving timing generator that provides driving timing signals to the current sourcing parts, wherein a driving timing signal is activated for a time period corresponding to a drive data during a corresponding light emission period.

7. The LED display device of claim 6, wherein, when the driving switch of each of the current sourcing parts is turned-on for a maximum period, an amount of current of the current source of each of the current sourcing parts corresponds to an amount of current which causes an image of the display panel to have white light having maximum brightness due to mixture of light emitted from the corresponding light emission units.

8. The LED display device of claim 1, wherein each of the driving sets includes:
a variable current source disposed between the interfacing line and the second power supply line, an amount of current flowing the variable current source varying based on a driving level signal; and
a driving level generator that provides the driving level signal to the variable current source,
wherein the driving level signal has a driving level corresponding to the drive data during a corresponding light emission period.

9. The LED display device of claim 1, wherein each of the driving sets includes:
a variable current source disposed between the interfacing line and the second power supply line, an amount of current flowing the variable current source varying based on a driving level signal;
a driving switch disposed between the interfacing line and the second power supply line and in series with the variable current source, the driving switch being turned on based on activation of a driving timing signal; and
a driving signal generator that generates the driving level signal and the driving timing signal.

10. The LED display device of claim 9, wherein
the driving level signal has a driving level corresponding to the drive data during a corresponding light emission period, and
the driving timing signal is activated a time period corresponding to the drive data during a corresponding light emission period.
